(19) United States
(12) Patent Application Publication
(10) Pub. No.: US 2016/0260106 A1
(43) Pub. Date: Sep. 8, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Masatsugu TONOIKE, Kanagawa (JP)

(73) Assignee: FUJI XEROX CO., LTD., Tokyo (JP)

(21) Appl. No.: 14/804,652

(22) Filed: Jul. 21, 2015

(30) Foreign Application Priority Data
Mar. 3, 2015 (JP) 2015-040918

(51) Int. Cl. G06Q 30/02; G06K 9/52; G06T 7/60; G06K 9/00

(52) U.S. Cl. CPC G06Q 30/0201; G06K 9/00624; G06K 9/52; G06T 7/60; G06K 2009/4666

(57) ABSTRACT

An information processing apparatus includes a first associating unit that associates information concerning a customer having entered a store through an entrance and exit with information concerning a line of flow of the customer from a photographed image of an inside of the store, a second associating unit that associates information concerning a line of flow of the customer from a cashier area to the entrance and exit with information concerning purchasing in the store, a third associating unit that associates information concerning a customer having entered the store through the entrance and exit with information concerning a customer having left the store through the entrance and exit, and a fourth associating unit that associates the information concerning the purchasing and information concerning the line of flow of the customer in the store using information associated by the first through third associating units.

### CROSS-REFERENCE TO RELATED APPLICATIONS

This application is based on and claims priority under 35 USC 119 from Japanese Patent Application No. 2015-040918 filed Mar. 3, 2015.

### BACKGROUND

### Technical Field

The present invention relates to an information processing apparatus, an information processing method, and a non-transitory computer readable medium.

### SUMMARY

According to an aspect of the invention, there is provided an information processing apparatus. The information processing apparatus includes a first associating unit that associates information concerning a customer having entered a store through an entrance and exit with information concerning a line of flow of the customer from a photographed image of an inside of the store, a second associating unit that associates information concerning a line of flow of the customer from a cashier area to the entrance and exit with information concerning purchasing in the store, a third associating unit that associates information concerning a customer having entered the store through the entrance and exit with information concerning a customer having left the store through the entrance and exit, and a fourth associating unit that associates the information concerning the purchasing and information concerning the line of flow of the customer in the store using information associated by the first through third associating units.

### BRIEF DESCRIPTION OF THE DRAWINGS

Exemplary embodiments of the present invention will be described in detail based on the following figures, wherein:

FIG. 1 illustrates the modular configuration of an exemplary embodiment;

FIG. 2A and FIG. 2B illustrate examples of the system configuration of the exemplary embodiment;

FIG. 3 illustrates an example of customers present in a store;

FIG. 4 is a flowchart illustrating a process example of the exemplary embodiment;

FIG. 5 illustrates a layout example of the store;

FIG. 6 illustrates an example of a data structure of a shop line-of-flow table;

FIG. 7 illustrates a process example of the exemplary embodiment;

FIG. 8 illustrates an example of the data structure of a shop line-of-flow table;

FIG. 9 illustrates a process example of the exemplary embodiment;

FIG. 10 illustrates a process example of the exemplary embodiment;

FIG. 11 illustrates an example of the data structure of an entry/exit table;

FIG. 12 illustrates a process example of the exemplary embodiment;

FIG. 13 illustrates a process example of the exemplary embodiment;

FIG. 14 illustrates an example of the data structure of a shop line-of-flow table;

FIG. 15 illustrates an example of the data structure of an entry/exit table;

FIG. 16 illustrates an example of the data structure of an ID related table;

FIG. 17A and FIG. 17B illustrate process examples of the exemplary embodiment; and

FIG. 18 is a block diagram illustrating an example of the hardware configuration of a computer that implements the exemplary embodiment.

### DETAILED DESCRIPTION

An exemplary embodiment of the present invention is described with reference to the drawings.

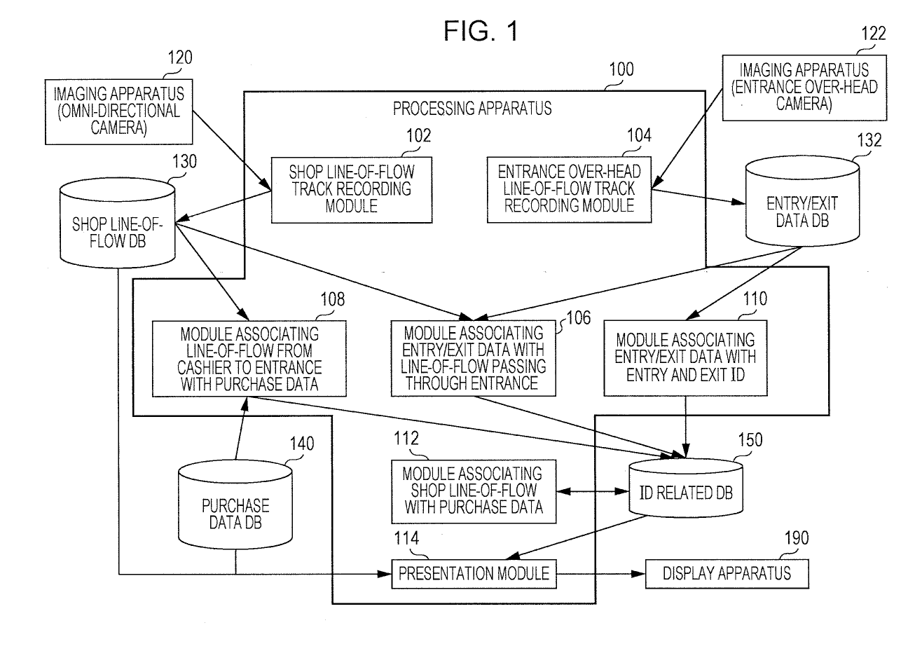

FIG. 1 illustrates the modular configuration of an exemplary embodiment.

The term module refers to a software component that is logically separable (a computer program), or a hardware component. The module of the exemplary embodiment refers to not only a module in a computer program but also a module in a hardware configuration. The discussion of the exemplary embodiment also serves as the discussion of computer programs for causing the modules to function (including a program that causes a computer to execute each step, a program that causes the computer to function as an element, or a program that causes the computer to implement each function), a system and a method. In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functions in a one-to-one correspondence. In software implementation, one module may be composed of one program or multiple modules may be composed of one program. One module may be composed of multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, transmission of instructions, and data reference relationship). The term “predetermined” means that something is decided in advance of a process of interest. The term “predetermined” is thus intended to refer to something that is decided in advance of a process of interest in the exemplary embodiment. Even after a process in the exemplary embodiment has started, the term “predetermined” refers to something that is decided in advance of a process of interest depending on a condition or a status of the exemplary embodiment at the present point of time or depending on a condition or status of the exemplary embodiment heretofore continuing down to the present point of time. If “predetermined values” are plural, the predetermined values may be different from each other, or two or more of the predetermined values (including all the values) may be equal to each other. A statement that “if A, B is to be performed” is intended to mean that it is determined whether something is A, and that if something is determined as A, an action B is to be taken. The statement becomes meaningless if the determination as to whether something is A is not performed.

The term “system” and the term “apparatus” refer to an arrangement where multiple computers, a hardware configuration, and an apparatus are interconnected via a communication network (including a one-to-one communication connection). The term “system” and the term “apparatus” also refer to an arrangement that includes a single computer, a hardware configuration, or an apparatus. The term “system” and the term “apparatus” have the same definition and are interchangeable with each other. The system in the context of the exemplary embodiment does not include a social system that is a social arrangement formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a RAM (random-access memory), an external storage medium, a memory device connected via a communication network, and a register within a CPU (central processing unit).

A processing apparatus 100 of the exemplary embodiment associates information concerning purchasing (hereinafter referred to as purchase data) with information concerning the line of flow of a customer in a store (hereinafter referred to as line-of-flow data). As illustrated in FIG. 1, the processing apparatus 100 includes a shop line-of-flow track recording module 102, an entrance over-head line-of-flow track recording module 104, a module 106 associating entry/exit data with line of flow passing through entrance, a module 108 associating line of flow from cashier to entrance with purchase data, a module 110 associating entry/exit data with entry and exit ID, a module 112 associating shop line of flow with purchase data, and a presentation module 114. Research may be performed to determine what a customer is going to purchase after what line of flow the customer has taken in a store, or conversely determine what line of flow a customer has taken to purchase what. For this reason, the line-of-flow data indicating the line of flow of a customer is associated with the purchase data indicating an item purchased by the customer.

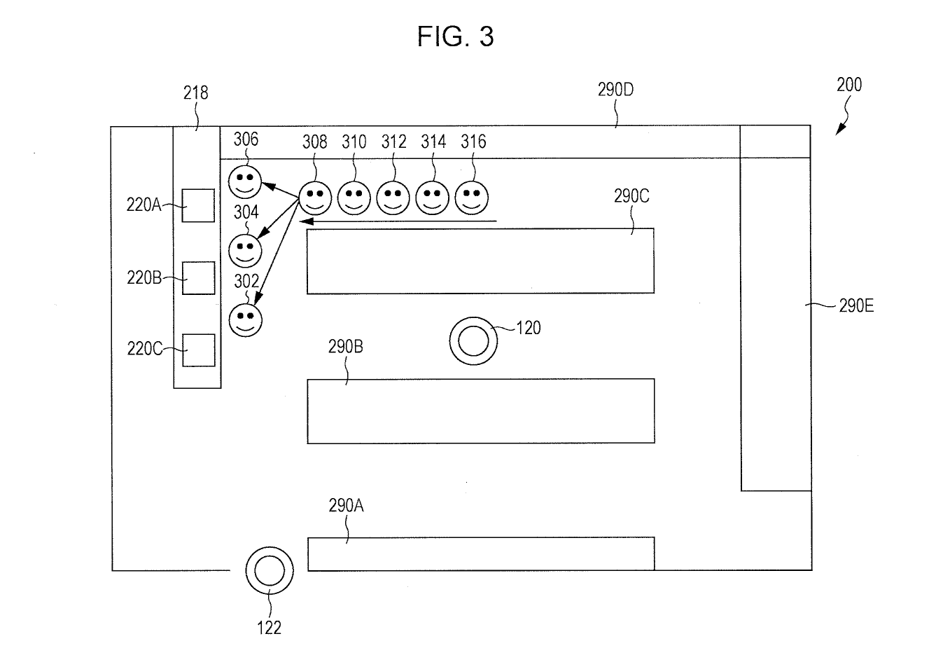

FIG. 3 illustrates an example of customers present in a store 200.

The store 200 includes an imaging apparatus (entrance over-head camera) 122, a store shelf 290A, store shelf 290B, store shelf 290C, store shelf 290D, and store shelf 290E. A customer may pick up an item, proceeds to a cashier counter 218, and pays for the item (customer 306 at a cash register 220A, customer 304 at a cash register 220B, and customer 302 at a cash register 220C). A line of customers waiting to pay (including customers 308, 310, 312, 314, and 316) may branches in a fork shape as illustrated in FIG. 3. While the customers are waiting, they typically stay stationary. If the customers stay stationary, it is difficult to discriminate them from the background and to extract the bodies of the customers. Such a difficulty occurs not only in the fork customer flow but also in a case where there occurs a line of waiting customers. Particularly, in the case of the fork customer flow, the order of the customers in the original line may not agree with the order of the customers in the ending of the payment. For example, customers 302, 304, and 306 may have lined up in this order, but they are not necessarily finishing their payments in this order. For example, the customer 306 may finish his or her payment earlier than the other two (customers 302 and 304) depending on the quantity of purchase and the experience of an operator of the register. In such a case, techniques of related art may erroneously associate the line-of-flow data with the purchase data. Also there is a case when a customer may approach the casher counter 218, but may purchase nothing at all. The association between the line-of-flow data and the purchase data is not obvious. Photographing the face of each customer at the casher counter 218 is not appropriate.

The processing apparatus 100 extracts the line-of-flow data and the purchase information, associates the line of flow of a customer at the entry of the customer with the line of flow of the customer at the exit. In this way, a shop line of flow is associated with the purchase information regardless of the line of customers at the cashier counter.

The functions and processes of the modules in the processing apparatus 100 and an apparatus connected to the processing apparatus 100 are described below with reference to FIG. 1.

The processing apparatus 100 receives a moving image stream from an imaging apparatus (omnidirectional camera) 120, an imaging apparatus (entrance over-head camera) 122, converts the moving image stream into the line-of-flow data, and then associates the line-of-flow data on the purchase data on the purchase data DB (database) 140. The process of the processing apparatus 100 is described below.

The imaging apparatus (omnidirectional camera) 120 is connected to a shop line-of-flow track recording module 102. The imaging apparatus (omnidirectional camera) 120 has the viewing angle of 180 degrees (or even 360 degrees). The imaging apparatus (omnidirectional camera) 120 is mounted on the ceiling of the store. The imaging apparatus (omnidirectional camera) 120 may communicate with the processing apparatus 100 using analog or digital communication. In the case of the digital communication, wireless communication or wired communication may be used. The processing apparatus 100 includes an interface that captures a camera image as digital data. The imaging apparatus (omnidirectional camera) 120 is not limited to an omnidirectional camera. The imaging apparatus (omnidirectional camera) 120 may be a two-dimensional camera, a three-dimensional camera, or a thermo-camera. The imaging apparatus (omnidirectional camera) 120 may be fixed or installed in a manner such that the angle, and location thereof is adjustable.

The shop line-of-flow track recording module 102 is connected to the imaging apparatus (omnidirectional camera) 120 and the shop line-of-flow DB 130. The shop line-of-flow track recording module 102 keeps track of a person using a camera installed within the store, and records the line of flow of the person.

The shop line-of-flow DB 130 is connected to the shop line-of-flow track recording module 102, the module 106 associating entry/exit data with line of flow passing through entrance, the module 108 associating line of flow from cashier to entrance with purchase data, and the presentation module 114. The shop line-of-flow DB 130 stores process results provided by the shop line-of-flow track recording module 102, and is accessed by the module 106 associating entry/exit data with line of flow passing through entrance or the module 108 associating line of flow from cashier to entrance with purchase data. More specifically, the shop line-of-flow DB 130 is a database that stores the shop lines of flow. A single line of flow identification (ID) is assigned to a line of flow of a person.

The imaging apparatus (entrance over-head camera) 122 is connected to the entrance over-head line-of-flow track recording module 104. The imaging apparatus (entrance over-head camera) 122 may have any viewing angle. The imaging apparatus (entrance over-head camera) 122 is mounted on the ceiling at the entrance and exit area of the store. The rest of the discussion is similar to the discussion of the imaging apparatus (omnidirectional camera) 120.

The entrance over-head line-of-flow track recording module 104 is connected to the imaging apparatus (entrance over-head camera) 122 and the entry/exit data DB 132. The entrance over-head line-of-flow track recording module 104 keeps track of a person who enters and leaves the store through the entrance and exit, and records an image, time, and direction in which the person crosses a border and coordinates of the person on the border (such as the center of the person).

The entry/exit data DB 132 is connected to the entrance over-head line-of-flow track recording module 104, the module 106 associating entry/exit data with line of flow passing through entrance, and the module 110 associating entry/exit data with entry and exit ID. The entry/exit data DB 132 stores the process results provided by the entrance over-head line-of-flow track recording module 104, and is accessed by the module 106 associating entry/exit data with line of flow passing through entrance and the module 110 associating entry/exit data with entry and exit ID. The entry/exit data DB 132 records entry/exit of customers.

The module 106 associating entry/exit data with line of flow passing through entrance is connected to the shop line-of-flow DB 130, the entry/exit data DB 132, and the ID related DB 150. The module 106 associating entry/exit data with line of flow passing through entrance associates information of a customer having entered the store through the entrance with information concerning the line of flow of the customer, from the photographed image of the store. The “information concerning the line of flow of the customer in the store” includes line-of-flow information of lines of flow of customers from the entrance/exit (entrance) to the cashier area or to a checkout waiting line of the customers waiting to pay. For example, the “information concerning the line of flow of the customer in the store” includes the line-of-flow of the customer having entered the store, selected an item, and then moved to the payment area to pay for the item. More specifically, an image of a person photographed from the entrance over-head position is associated with a line of flow acquired by the shop line-of-flow track recording module 102.

The module 108 associating line of flow from cashier to entrance with purchase data is connected to the shop line-of-flow DB 130, the purchase data DB 140, and the ID related DB 150. The module 108 associating line of flow from cashier to entrance with purchase data associates the information concerning the line of flow of the customer from the cashier area to the entrance and exit in the store with the purchasing in the store (hereinafter referred to as purchase data). The “information concerning the line of flow of the customer from the cashier area to the entrance and exit in the store” includes the line-of-flow information of the customer who has paid extending from the cashier area to the entrance and exit (exit). The “cashier area” is a location where the customer pays for the item the customer wants to purchase, and typically refers to the vicinity of a place where the cashier counter is installed (hereinafter referred to as a cashier counter). More specifically, time at which the line of flow of the customer leaves from the cashier counter is associated with the purchase data.

The module 110 associating entry/exit data with entry and exit ID is connected to the entry/exit data DB 132, and the ID related DB 150. The module 110 associating entry/exit data with entry and exit ID associates the information concerning the customer having entered the store through the entrance and exit with the information concerning the customer having left the store through the entrance and exit. The module 110 associating entry/exit data with entry and exit ID may associate the information concerning the customer having entered the store with the information concerning the customer having left the store by associating the image of the customer having entered the store with the image of the customer having left the store in symmetrical with the image of the customer having entered the store. More specifically, an entry ID and an exit ID are associated using entry and exit images (images photographed by the imaging apparatus (omnidirectional camera) 120 or images photographed by the imaging apparatus (entrance over-head camera) 122).

The module 112 associating shop line of flow with purchase data is connected to the ID related DB 150. The module 112 associating shop line of flow with purchase data associates the information concerning the purchasing with the information concerning the line of flow of the customer in the store, using the information associated by the module 106 associating entry/exit data with line of flow passing through entrance, the module 108 associating line of flow from cashier to entrance with purchase data, and the module 110 associating entry/exit data with entry and exit ID. The module 112 associating shop line of flow with purchase data extracts the “information concerning the customer having entered the store” from the “information concerning the line of flow of the customer in the store”, extracts the “information concerning the customer having left the store” from the “information concerning the customer having entered the store”, extracts the “information concerning the line of flow of the customer from the payment area to the entrance and exit” from the “information concerning the customer having left the store”, and extracts the “information concerning the purchasing” from the “information concerning the line of flow of the customer from the payment area to the entrance and exit”. The module 112 associating shop line of flow with purchase data thus associates the “information concerning the purchasing” with the “information concerning the line of flow of the customer in the store”. More specifically, the module 112 associating shop line of flow with purchase data associates a shop line-of-flow ID (an ID of a line of flow from the entrance and exit to the checkout waiting line for the cashier counter) with a receipt ID based on the association obtained by the module 106 associating entry/exit data with line of flow passing through entrance, the module 108 associating line of flow from cashier to entrance with purchase data, and the module 110 associating entry/exit data with entry and exit ID.

The purchase data DB 140 is connected to the module 108 associating line of flow from cashier to entrance with purchase data and the presentation module 114. More specifically, the purchase data DB 140, such as a point of sale system (POS), stores the purchase data. A receipt ID is assigned to each receipt. The purchase data DB 140 stores settlement time. Time is expressed in minutes. Time here may include date and time (year, month, day, hours, minutes, seconds, and a fraction of the second, or a combination thereof).

The ID related DB 150 is connected to the module 106 associating entry/exit data with line of flow passing through entrance, the module 108 associating line of flow from cashier to entrance with purchase data, the module 110 associating entry/exit data with entry and exit ID, the module 112 associating shop line of flow with purchase data, and the presentation module 114. More specifically, the ID related DB 150 associates an entry ID, an exit ID, a shop line-of-flow ID, and a receipt ID. The ID related DB 150 may store a table of these IDs, or multiple tables, each table associating one type of ID with another type of ID.

The presentation module 114 is connected to the shop line-of-flow DB 130, the purchase data DB 140, the ID related DB 150, and the display apparatus 190. The presentation module 114 causes the display apparatus 190 to display the process results of the module 112 associating shop line of flow with purchase data, using the data stored on the shop line-of-flow DB 130, the purchase data DB 140, and the ID related DB 150. The process results of the module 112 associating shop line of flow with purchase data (data on the ID related DB 150) may be printed on a printer, transmitted via an image transmitting apparatus, such as a facsimile machine, written on a storage device, such as a purchase database, stored a storage medium, such as a memory card, or transferred to another information processing apparatus.

The display apparatus 190 is connected to the presentation module 114. The display apparatus 190 displays association results of the shop line of flow and the purchase data.

The “information concerning the customer having entered or left the store through the entrance and exit”, and the “information concerning the line of flow of the customer in the store and the information concerning the line of flow of the customer from the cashier area to the entrance and exit in the store” may be extracted from an image obtained by photographing the inside of the store. More specifically, the “information concerning the customer having entered or left the store through the entrance and exit”, and the “information concerning the line of flow of the customer in the store and the information concerning the line of flow of the customer from the cashier area to the entrance and exit in the store” may be extracted from the image photographed by the imaging apparatus (omnidirectional camera) 120. In this case, the imaging apparatus (omnidirectional camera) 120 also photographs the image at the entrance and exit of the store.

The “information concerning the customer having entered or left the store through the entrance and exit” may be extracted from a first image photographed from above the entrance and exit. More specifically, the “information concerning the customer having entered or left the store through the entrance and exit” may be extracted from the image photographed by the imaging apparatus (entrance over-head camera) 122. The “information concerning the line of flow of the customer in the store and the information concerning the line of flow of the customer from the cashier area to the entrance and exit in the store” may be extracted from a second image obtained by photographing the inside of the store. More specifically, the “information concerning the line of flow of the customer in the store and the information concerning the line of flow of the customer from the cashier area to the entrance and exit in the store” may be extracted from an image photographed by the imaging apparatus (omnidirectional camera) 120.

The “information concerning the customer having entered or left the store through the entrance and exit”, and the “information concerning the line of flow of the customer in the store and the information concerning the line of flow of the customer from the cashier area to the entrance and exit in the store” may be extracted from an image obtained by the imaging apparatus (entrance over-head camera) 122. In such a case, the imaging apparatus (entrance over-head camera) 122 photographs not only the entrance and exit of the store but also the inside of the store.

The “first and second images” may be a combined image of multiple images photographed by multiple cameras (multiple imaging apparatuses (multiple omnidirectional cameras) 120 and multiple imaging apparatuses (multiple entrance over-head cameras) 122).

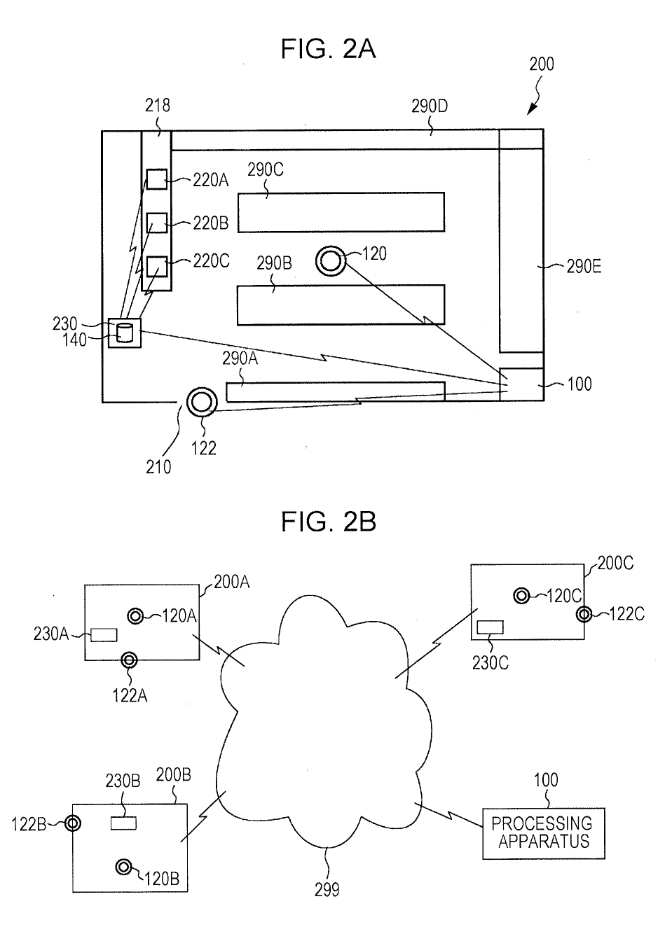

FIG. 2A and FIG. 2B illustrate examples of the system configuration of the exemplary embodiment.

FIG. 2A illustrates the processing apparatus 100 installed in the store 200.

The store 200 includes the processing apparatus 100, imaging apparatus (omnidirectional camera) 120, imaging apparatus (entrance over-head camera) 122, entrance 210, cashier counter 218, purchase data memory apparatus 230, store shelf 290A, store shelf 290B, store shelf 290C, store shelf 290D, and store shelf 290E. The purchase data memory apparatus 230 includes the purchase data DB 140. Mounted on the casher counter 218 are cash register apparatus 220A, cash register apparatus 220B, and cash register apparatus 220C.

The processing apparatus 100, the imaging apparatus (omnidirectional camera) 120, the imaging apparatus (entrance over-head camera) 122, and the purchase data memory apparatus 230 are mutually connected via a communication network. The communication network may be a wireless network, a wired network, or a combination thereof. The communication network may be intranet as communication infrastructure.

Referring to FIG. 2B, the processing apparatus 100 is installed outside the store 200.

The imaging apparatus (omnidirectional camera) 120, the imaging apparatus (entrance over-head camera) 122, and the purchase data memory apparatus 230 are installed in each store 200. The processing apparatus 100, store 200A, store 200B, and store 200C are interconnected through a communication network 299. The communication network 299 may be the Internet, or Intranet, as the communication infrastructure. Alternatively, the function of the processing apparatus 100 may be implemented in a cloud service.

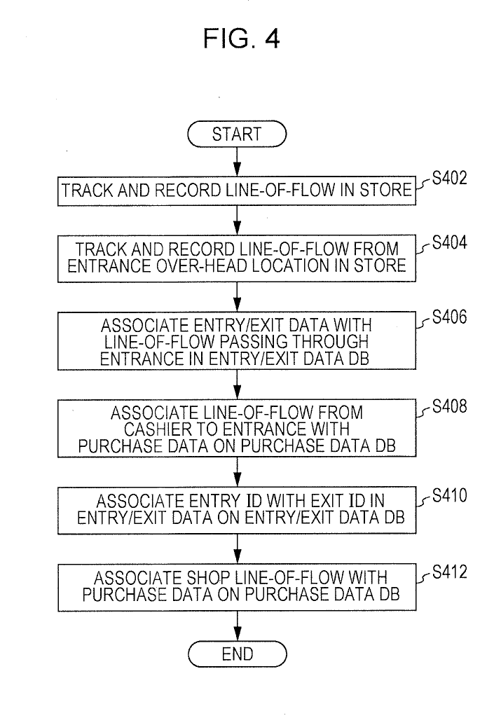

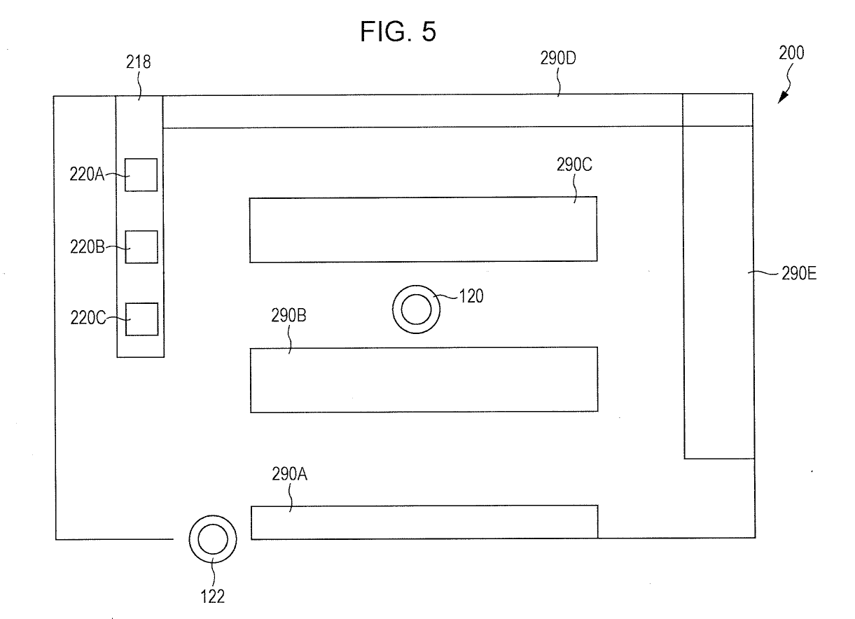

FIG. 4 is a flowchart illustrating a process example of the exemplary embodiment. The operation in each step is described below with reference to FIG. 5 through FIG. 17B.

In step S402, the shop line-of-flow track recording module 102 keeps track of and records the lines of flow in the store. More specifically, the shop line-of-flow track recording module 102 uses the imaging apparatus (omnidirectional camera) 120 installed in an area to keep track of the customers from the entrance and exit (entry) to the checkout waiting line to the cashier counter, and from the cashier counter to the entrance and exit (exit).

The process of the processing apparatus 100 is based on the assumption that information from the imaging apparatus (omnidirectional camera) 120 mounted on the ceiling within the area of FIG. 5 is used. The camera does not necessarily have to be an omnidirectional camera. Any camera is acceptable as long as the camera is installed such that the line of flow is being tracked without interruptions.

A relate-art technique may be used to track a person. The background subtraction (Zivkovic 2004) by MOG 2 may be used to detect a person in a first stage of tracking, and the KLT tracking method (Tomasi et al. 1991) may be used to track the person in a second stage of tracking.

On the assumption that the processing apparatus 100 uses the information from the imaging apparatus (omnidirectional camera) 120, there is no problem even if the line of flow of a customer waiting in a line for the cashier counter is broken.

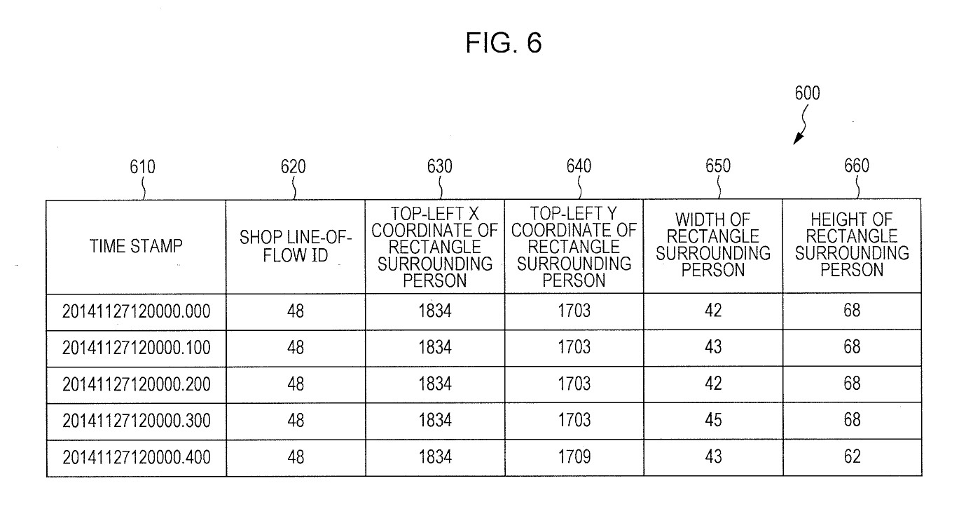

As a result of tracking, at least, a time stamp, a tracking ID, and coordinates information of a rectangle surrounding a person are typically output. The tracking ID is herein referred to as a shop line-of-flow ID. The process results in step S402 are stored in a shop line-of-flow table 600. FIG. 6 illustrates an example of the data structure of the shop line-of-flow table 600. The shop line-of-flow table 600 includes a time stamp column 610, a shop line-of-flow ID column 620, a column 630 for the top-left X coordinate a rectangle surrounding a person, a column 640 for the top-left Y coordinate of the rectangle surrounding the person, a column 650 for the width of the rectangle surrounding the person, and a column 660 for the height of the rectangle surrounding the person.

The time stamp column 610 stores a time stamp (date and time of photographing) of a photographed image. The shop line-of-flow ID column 620 stores information uniquely identifying the line of flow of a customer in the store (the shop line-of-flow ID) in the exemplary embodiment. The column 630 for the top-left X coordinate the rectangle (circumscribing rectangle) surrounding the person stores the top-left X coordinate of the rectangle surrounding the person of the shop line-of-flow ID. The column 640 for the top-left Y coordinate of the rectangle surrounding the person stores the top-left Y coordinate of the rectangle surrounding the person of the shop line-of-flow ID. The column 650 for the width of the rectangle surrounding the person stores the width of the rectangle surrounding the person of the shop line-of-flow ID. The column 660 for the height of the rectangle surrounding the person stores the height of the rectangle surrounding the person of the shop line-of-flow ID.

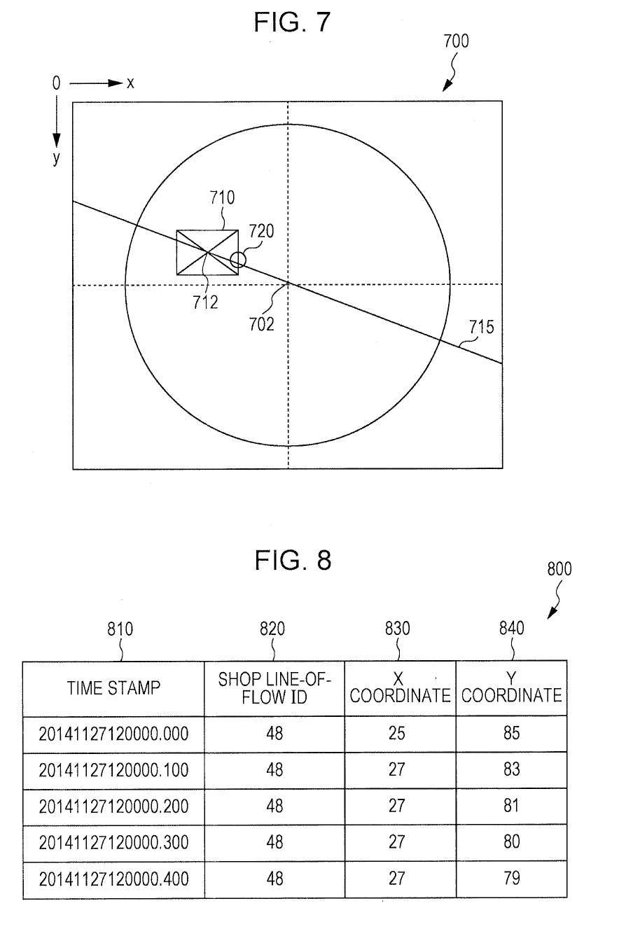

Since a person handled as a rectangle is difficult to process, coordinates of the feet of a person may be calculated from the rectangle information, and the coordinates may be used as the position information of the person. In the calculation of the foot coordinates, a line passing through the center of the image and the center of the rectangle surrounding the person is drawn, and two intersections of the line across the rectangle are determined. As illustrated in FIG. 7, the intersection closer to the center of the image 702 is set to be the foot coordinates. More specifically, a coordinate system is set up with the origin thereof at the top left of an image 700 photographed by the imaging apparatus (omnidirectional camera) 120, and person rectangle information 710 of a customer is located as illustrated in FIG. 7. In such a case, a line 715 connecting the image center 702 of the image 700 and a person rectangle center 712 of the person rectangle information 710 intersects the output of the person rectangle information 710 (of four line segments), and the foot coordinates 720 as one of the intersections closer to the image center 702 is set to be the foot coordinates.

Since the image from the omnidirectional camera is distorted and difficult to handle, geometric correction technique of related art may be used to remove a distortion to convert the image into the line-of-flow data in a rectangular plane coordinate system. In a simple method, markers are attached onto the floor at regular intervals, and an omnidirectional camera image is thus captured from the store. A regression equation to convert the distance from the center point may thus be derived. For convenience of explanation, the processing apparatus 100 employs the line-of-flow data in the rectangular plane coordinate system.

The process results using the foot coordinates in step S402 may be stored as a shop line-of-flow table 800. FIG. 8 illustrates an example of the data structure of the shop-line of-flow table 800. The shop line-of-flow table 800 includes a time stamp column 810, a shop line-of-flow ID column 820, an X coordinate column 830, and a Y coordinate column 840.

The time stamp column 810 stores the time stamp of a photographed image. The shop line-of-flow ID column 820 stores the shop line-of-flow ID. The X coordinate column 830 stores the X coordinate of the foot coordinates of the shop line-of-flow ID. The Y coordinate column 840 stores the Y coordinate of the foot coordinates of the shop line-of-flow ID.

The shop line-of-flow track recording module 102 acquires two types of lines of flow as described below.

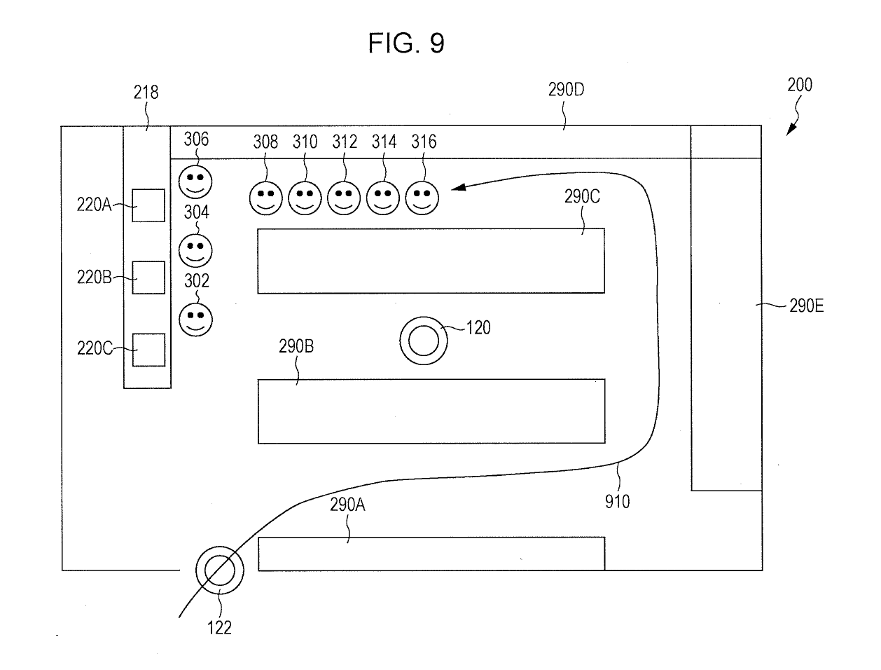

Line of flow from the entrance to the checkout waiting line for the cashier counter (see a line of flow 910 from the entrance to the checkout waiting line for the casher counter as illustrated in FIG. 9)

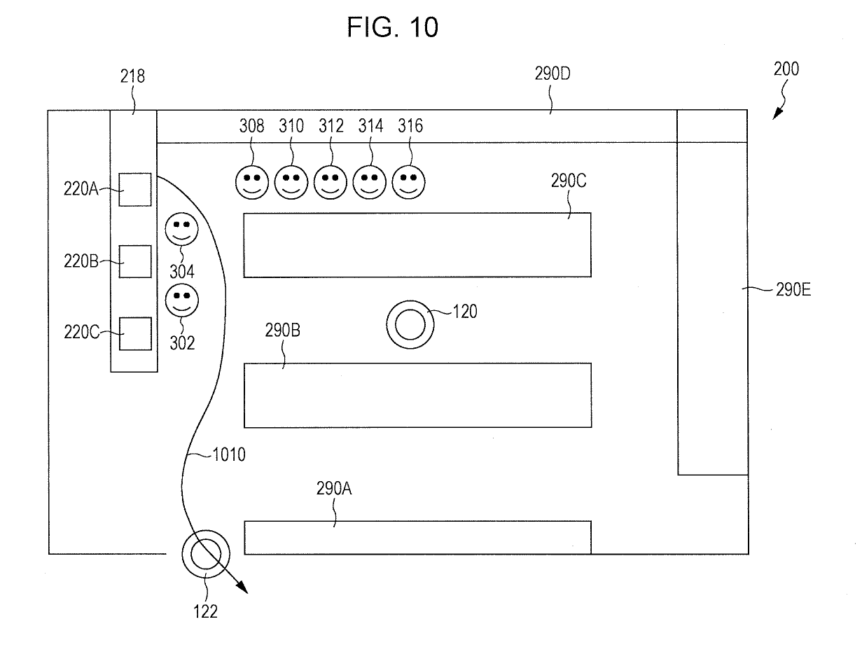

Line of flow from the cashier counter to the entrance (see a line of flow 1010 from the cashier counter to the entrance as illustrated in FIG. 10).

It is now assumed that the coordinate information of the cashier counter and the entrance is pre-stored.

If an entire target area is not covered by a single omnidirectional camera, the visual cone intersection technique (Kubota et al. 2008) using multiple cameras may be used to acquire lines of flow in the store.

Patent Literature related to the techniques described in step S402 is as follows:

“Zivkovic, Zoran “Improved adaptive Gaussian mixture model for background subtraction,” Pattern Recognition, 2004, ICPR 2004, Proceedings of the 17th International Conference on. Vol. 2, IEEE, 2004”

“Carlo Tomasi and Takeo Kanade, Detection and Tracking of Point Features, Carnegie Mellon University Technical Report CMU-CS-91-132, April 1991”

“Susumu KUBOTA, Masayuki MARUYAMA, and Tomonori IKUMI, “Customer Trajectory Detection System Using Multiple Omnidirectional Camera, Toshiba Review 63, 10 (2008), 44-47”

In step S404, the entrance over-head line-of-flow track recording module 104 tracks and records the line of flow from right above the entrance of the store. More specifically, the entrance over-head line-of-flow track recording module 104 records the line of flow of a person who moves below the entrance over-head location using the imaging apparatus (entrance over-head camera) 122. In the process of the entrance over-head line-of-flow track recording module 104, a background difference equivalent to the background difference of the shop line-of-flow track recording module 102 and the KLT tracking method are used. The structure of the line-of-flow data may be identical to the structure of the shop line-of-flow table 600 of FIG. 6.

Images of a customer who crosses the border between the inside of the store and the outside of the store (in the entry or exit of the customer) are stored.

Also stored are the time and direction in which the customer crosses the border (the direction is a direction of the movement of the customer, and includes an entry direction in which the customer enters the store, and an exit direction in which the customer leaves the store), and the coordinates on the border (such as the center of the customer).

The entry and exit are determined by referencing which side the customer crosses a line segment representing the predetermined entrance and exit from.

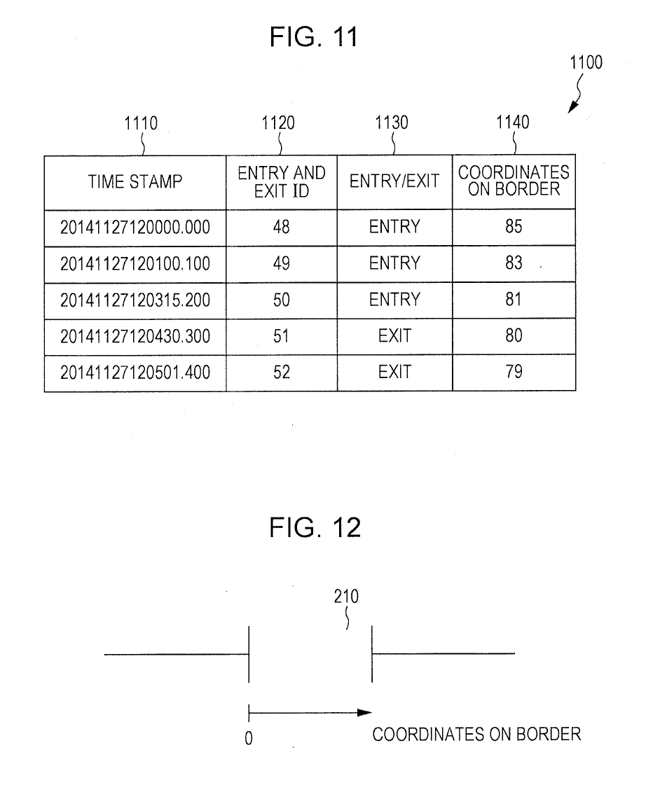

An image file may be identified by naming the file with an entry and exit ID. The process results in step S404 are stored in an entry/exit table 1100. FIG. 11 illustrates an example of the data structure of the entry/exit table 1100. The entry/exit table 1100 includes a time stamp column 1110, an entry and exit ID column 1120, an entry/exit column 1130, and a border coordinate column 1140.

The time stamp column 1110 stores a time stamp of a photographed image. The entry and exit ID column 1120 stores information uniquely identifying an entry and exit (entry and exit ID). The entry/exit column 1130 stores an indication as to whether the entry and exit ID is for an entry or an exit. The border coordinate column 1140 stores the coordinate of the entry and exit ID on the border. The coordinate on the border is one dimensional at an entrance 210 as illustrated in FIG. 12.

The entry and the exit may be listed in separate tables. For example, an entry table and an exit table may be two different tables. The entry table may include the time stamp column 1110, the entry and exit ID column 1120, and the border coordinate column 1140. The exit table may include the time stamp column 1110, the entry and exit ID column 1120, and the border coordinate column 1140.

In step S406, the module 106 associating entry/exit data with line of flow passing through entrance associates entry/exit data on the entry/exit data DB 132 with the line of flow passing through the entrance. More specifically, the module 106 associating entry/exit data with line of flow passing through entrance associates the entry/exit data with the shop line-of-flow ID acquired by the shop line-of-flow track recording module 102, based on the time stamp and the association between the coordinates.

If the entry/exit data is data for an entry, the entry/exit data is associated with the line of flow from the entry to the cashier counter. Conversely, if the entry/exit data is data for an exit, the entry/exit data is associated with the line of flow from the cashier counter to the exit.

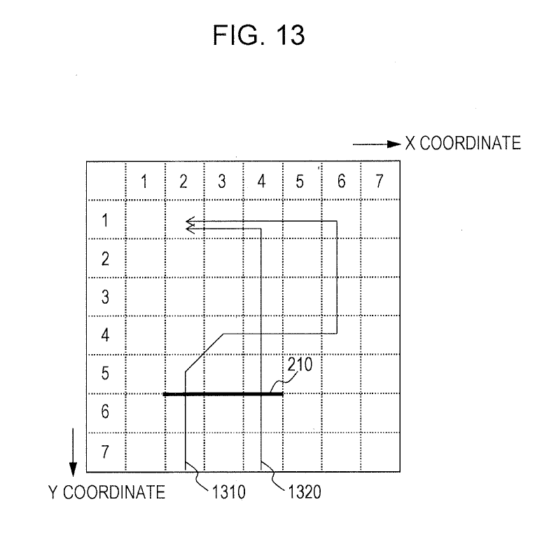

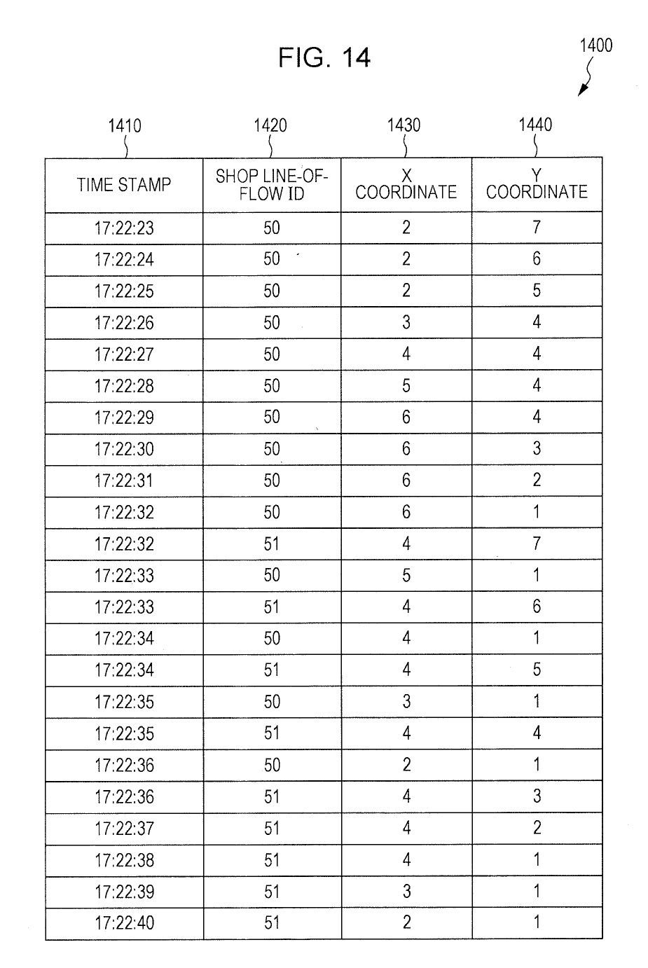

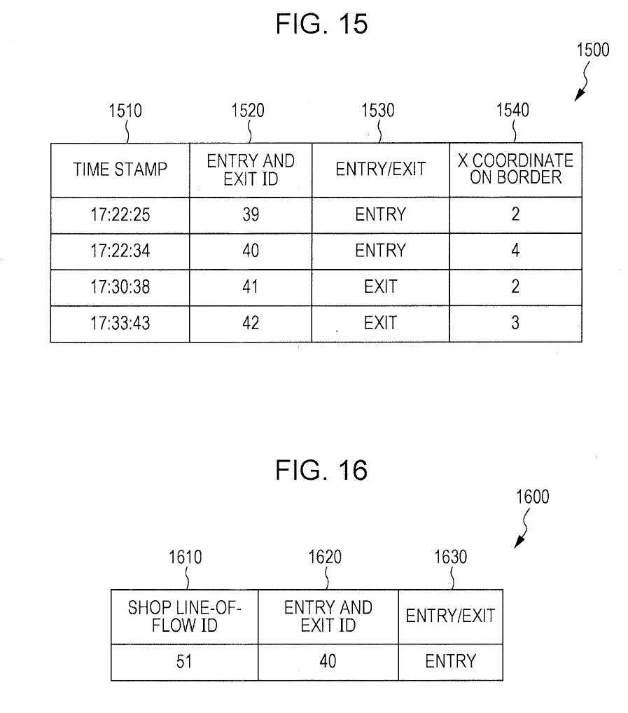

FIG. 13 is a plan view of the store in a coordinate system with coarsely defined coordinates. FIG. 14 illustrates an example of the shop line-of-flow data in a shop line-of-flow table 1400. FIG. 15 illustrates an example of the entry/exit data in an entry/exit table 1500. The shop line-of-flow table 1400 is similar in data structure to the shop line-of-flow table 800. The entry/exit table 1500 is similar in data structure to the entry/exit table 1100.

A row related to an entry is successively retrieved at a time from the entry/exit table 1500 of FIG. 15. For example, the following entry/exit data (at the second row of the entry/exit table 1500) is retrieved.

(17:22:34, 40, entry, 4)

If the time stamp (17:22:34) is searched for in the shop line-of-flow table 1400 of FIG. 14, the shop line-of-flow data (14th and 15th rows of the shop line-of-flow table 1400) is hit and retrieved.

(17:22:34, 50, 4, 1)

(17:22:34, 51, 4, 5)

Only data having a location close to the entrance (the Y coordinate is 5, and the X coordinate is 1, 2, 3, 4, or 5) is extracted from the hit shop line-of-flow data as illustrated in FIG. 13. The following shop line-of-flow data (the 15th row of the shop line-of-flow table 1400) remains:

(17:22:34, 51, 4, 5)

The processing apparatus 100 then whether X coordinate positions passing through the entrance remains the same. If the X coordinate positions are different, that data is excluded. In this case, the shop line-of-flow data and the entry/exit data have 4 in the X coordinate, and are not excluded.

If the time stamp (17:22:33), namely the time stamp one minute earlier, with the same shop line-of-flow ID (51), is searched for in the shop line-of-flow table 1400 of FIG. 14, the following shop line-of-flow data (13th of the shop line-of-flow table 1400) is hit and retrieved.

(17:22:33, 51, 4, 6)

The shop line-of-flow data is examined to determine whether the location is outside the store or not. Since the location (4, 6) is outside the store as illustrated in FIG. 13, the line-of-flow data having the shop line-of-flow ID=51 (a line of flow 1320 in FIG. 13) is a line of flow for an entry. If the direction is identical to the direction of the retrieved entry/exit data, the line-of-flow data remains. If the direction is not identical to the direction of the extracted entry/exit data, the line-of-flow data is deleted. In this case, the extracted entry/exit data is for the entry, and the line-of-flow data remains.

In this way, the entry data of the entry and exit ID=40 corresponds to the shop line-of-flow data of the shop line-of-flow ID=51.

The association thus obtained is recorded as a table 1600 of FIG. 16 on the ID related DB 150. FIG. 16 illustrates an example of the data structure of the ID related table 1600. The ID related table 1600 includes a shop line-of-flow ID column 1610, an entry and exit ID column 1620, and an entry/exit column 1630.

The shop line-of-flow ID column 1610 stores the shop line-of-flow ID. The entry and exit ID column 1620 stores the entry and exit ID corresponding to the shop line-of-flow ID. The entry/exit column 1630 stores an indication whether the entry and exit ID is for an entry or exit.

The above operation is described for exemplary purposes. Alternatively, data within the shop line-of-flow table 1400 of FIG. 14 may be selected first and the operation responsive to the selected data may be performed.

In the matching of the time stamp, the time stamps do not necessarily have to be precisely the same. For example, if the two time stamps fall within a range of 0.5 second, they may be determined to match each other.

In step S408, the module 108 associating line of flow from cashier to entrance with purchase data associates the line of flow from the cashier counter to the entrance with the purchase data on the purchase data DB 140. More specifically, the module 108 associating line of flow from cashier to entrance with purchase data associates time the customer leaves the cashier counter in the line of flow with the purchase data. The association method may be similar to the association method of the module 106 associating entry/exit data with line of flow passing through entrance. If data is preset at the same time, the order relationship has a higher priority.

The order of the process is described below.

Step A1 A receipt (receipt data) is retrieved from the purchase data DB 140.

Step A2 Data having time close to the time of the retrieved receipt is retrieved from the shop line-of-flow DB 130.

Step A3 The processing apparatus 100 determines whether the location of the retrieved shop line-of-flow data is in front of the cashier counter.

Step A4 The processing apparatus 100 determines whether the retrieved shop line-of-flow data is a line of flow for an exit. Data of time later in the future than the retrieved line-of-flow data and having the shop line-of-flow ID of the retrieved shop line-of-flow data is retrieved from the shop line-of-flow DB 130. The processing apparatus 100 then determines that the data indicates whether the line-of-flow data has crossed the border from within the store to outside the store.

Step A5 If multiple pieces of the shop line-of-flow data remain as association candidates at this phase, which data to associate with the shop line-of-flow data is determined by referencing the order relationship. For example, the two receipts at 20:15 may be present, and the currently retrieved receipt may be the second one. The second receipt is associated with the data of the second time data out of the remaining shop line-of-flow data.

Step A6 The association between the receipt ID and the shop line-of-flow ID is stored onto the ID related DB 150.

Step A7 Processing returns to step A1 if an unprocessed receipt remains.

An example of a data format as the process results in step S408 is as follows:

(Time stamp, shop line-of-flow ID (the cashier counter to entrance), receipt ID)

In step S410, the module 110 associating entry/exit data with entry and exit ID associates the ID for the entry and the ID for the exit in the entry/exit data on the entry/exit data DB 132. More specifically, the module 110 associating entry/exit data with entry and exit ID associates the ID of the customer leaving the store with the ID of the customer entering the store on the entry/exit data DB 132 using a pre-captured still image on the border.

The module 110 associating entry/exit data with entry and exit ID retrieves exit information one piece by one piece in time sequence from the entry/exit data DB 132. For example, the following exit information (third row of the entry/exit table 1500) may now be retrieved:

(17:30:48, 41, exit, 2)

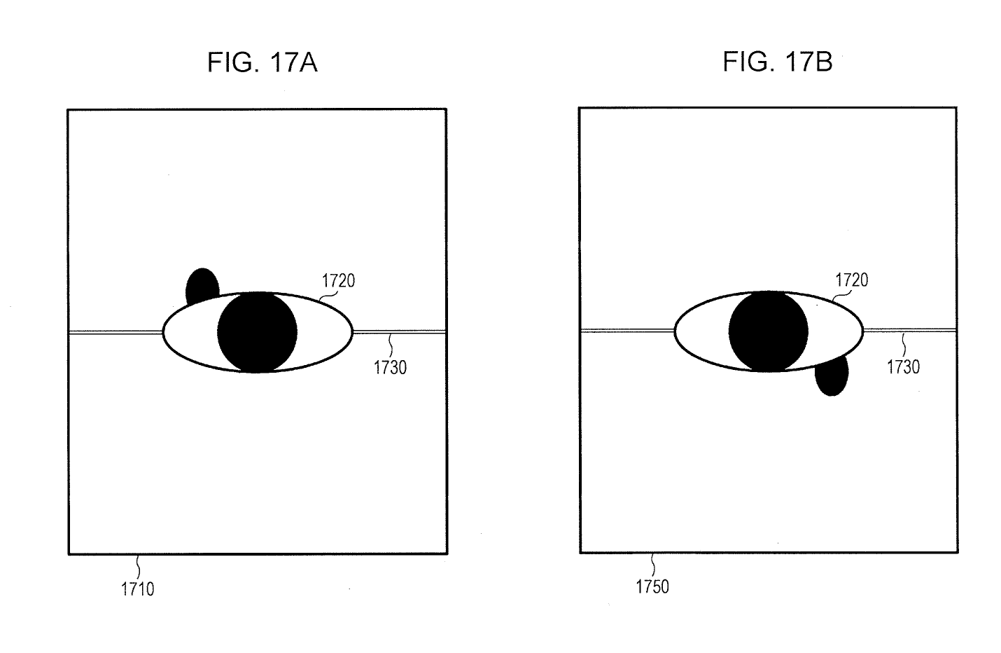

The still image on the border may now be stored with a name “41.jpg”. For example, the still image may be an exit image 1750 illustrated in FIG. 17B. In the exit image 1750, a customer 1720 on the border 1730 is photographed. In this example, the customer 1720 is photographed when he or she is moving in the exit direction (up to down direction in FIG. 17B).

Entry information is retrieved in time sequence one piece by one piece from the entry/exit data DB 132, and an image on the border corresponding to thereto is successively checked against “41.jpg” for personal identification. For example, the exit image 1750 is checked against an entry image 1710 of FIG. 17A. The entry image 1710 includes the customer 1720 on the border 1730. The entry image 1710 is photographed when the customer 1720 is moving in the direction of entry (from down to up in FIG. 17A). In the matching process, an image resulting from rotating the exit image 1750 by 180 degrees may be used. This is because the direction the customer looks toward the entry is opposite to the direction the customer looks toward the exit. The degree of similarity between the images may be calculated, or features may be extracted from the two images. The personal identification technique of related art (Ijiri et al. 2011) may be used.

The entry data having an entrance over-head image closest to 41.jpg is determined to be associated with the exit ID having an entry ID=41, and a set of the entry and exit ID (entry) and the entry and exit ID (exit) is stored on the ID related DB 150.

An example of the data format as the process results in step S410 is as follows:

(entry and exit ID (entry), entry and exit ID (exit))

The above process is repeated until all the exit data is processed.

In the exemplary embodiment, the entry and exit are associated using the entrance over-head image. The camera is not limited to the one installed at the entrance over-head location. Any camera may be acceptable as long as the camera captures the image of a person at the entry or exit at a high enough level that permits personal identification.

A line-of-flow tracking camera installed in the store that tracks the entry and exit of a customer at a high enough level that permits personal identification may be used to associate the entry and exit.

The literature described in step S410 is “Yoshihisa IJIRI, Yasutomo KAWANISHI, Hiroshi MURASE, and Michihiko MINOH,” A Survey: Person Re-identification Algorithms“, Technical Committee on Pattern Recognition and Media Understanding (PRMU), 2011-11”

In step S412, the module 112 associating shop line of flow with purchase data associates the shop line of flow with the purchase data on the purchase data DB 140. More specifically, the module 112 associating shop line of flow with purchase data associates the purchase data with the shop line of flow by following the association.

The ID relationship obtained up until this process is described below.

“Shop line-of-flow ID (the entrance to the checkout waiting line)” and “entry and exit ID (entry)” (process results by the module 106 associating entry/exit data with line of flow passing through entrance)

“Entry and exit ID (entry)” and “entry and exit ID (exit)” (process results by the module 110 associating entry/exit data with entry and exit ID)

“Entry and exit ID (exit)” and “Shop line-of-flow ID (the cashier counter to the entrance)” (process results by the module 106 associating entry/exit data with line of flow passing through entrance)

“Shop line-of-flow ID (the cashier counter to the entrance)” and the “receipt ID” (process results by the module 108 associating line of flow from cashier to entrance with purchase data)

From these IDs, tracking may be made as follows: “shop line-of-flow ID (the entrance to the checkout waiting line)”→“entry and exit ID (entry)”→“entry and exit ID (exit)”→“shop line-of-flow ID (the cashier counter to the entrance)”→“receipt ID”.

In this way, the “shop line-of-flow ID (the entrance to the checkout waiting line)” is associated with the “receipt ID”.

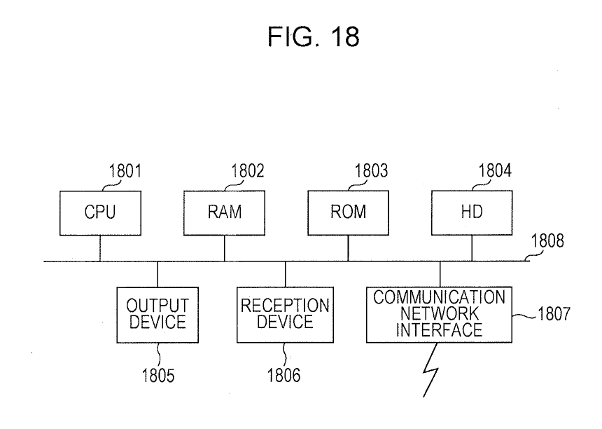

A computer hardware configuration of a computer on which programs as the exemplary embodiment run is a standard computer as illustrated in FIG. 18. Specifically, the computer hardware configuration is a computer that may serve as a personal computer or a server. More specifically, a central processing unit (CPU) 1801 is used as a processor (arithmetic processor), and a RAM 1802, a ROM 1803, and a HD 1804 are used as a storage device. A hard disk or a solid state drive (SSD) may be used for the HD 1804. The computer includes the CPU 1801 that executes programs such as the shop line-of-flow track recording module 102, the entrance over-head line-of-flow track recording module 104, the module 106 associating entry/exit data with line of flow passing through entrance, the module 108 associating line of flow from cashier to entrance with purchase data, the module 110 associating entry/exit data with entry and exit ID, the module 112 associating shop line of flow with purchase data, and the presentation module 114. The computer further includes the RAM 1802 that stores the programs and data, the ROM 1803 that stores a program to start up the computer and other programs, the HD 1804 that is an auxiliary storage device (such as a flash memory)(having the functions of the shop line-of-flow DB 130, the entry/exit data DB 132, the purchase data DB 140, and the ID related DB 150), a reception device 1806 that receives data responsive to an operation that a user performs on a keyboard, a mouse, a touchpanel, and the like, an output device 1805 such as a CRT or a liquid-crystal display (the output device 1805 may have the function of the display apparatus 190), a communication network interface 1807, such as a network interface card, for connection with a communication network (the communication network interface 1807 may have the communication function with the imaging apparatus (omnidirectional camera) 120 or the imaging apparatus (entrance over-head camera) 122), and a bus 1808 that interconnects these elements to exchange data thereamong. Multiple computers of this type may be interconnected to each other via a network.

A computer program of the exemplary embodiment may be read as software onto the system of the hardware configuration, and the exemplary embodiment is thus implemented with the software and hardware resources operating in cooperation.

The hardware configuration of FIG. 18 indicates a configuration example only. The exemplary embodiment is not limited to this hardware configuration of FIG. 18 and may be acceptable in any form as long as the modules of the exemplary embodiment are implemented. For example, some modules may be implemented using an application specific integrated circuit (ASIC) or the like. In another example, some modules may be in an external system and connected to the system of FIG. 18 via a communication network. In yet another example, plural systems of FIG. 18 may be interconnected to each other via a communication line such that the systems operate in concert with each other. One of the modules may be incorporated not only in a personal computer, but also in a mobile information communication apparatus (such as a cellular phone, a smart phone, a mobile device, or a wearable computer), a digital appliance, a robot, a copying machine, a facsimile device, a scanner, a printer, or a multi-function apparatus (an image processing apparatus having at least two of the functions of the scanner, the printer, the copying machine, and the facsimile device).

The above-described program may be supplied in a stored state on a recording medium. The program may also be provided via communications. In such a case, the above-described program may be understood as an invention of a “non-transitory computer readable recording medium storing the program”.

The “non-transitory computer readable recording medium storing the program” refers to a computer readable recording medium storing the program, and is used to install the program, to execute the program, or to distribute the program.

The recording media include digital versatile disk (DVD), compact disk (CD), Blu-ray disk (registered trademark), magnetooptical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM” complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a wireless network, or a combination thereof. The wired and wireless networks may include a local-area network (LAN), a metropolitan-area network (MAN), a wide-area network (WAN), the Internet, an intranet, and an extranet. The program in whole or in part may be transmitted over a carrier wave.

The program may be part of another program, or may be stored on the recording medium together with another program. The program may be split and split programs may then be separately stored on the recording media. The program may be processed in any fashion before being stored as long as the program remains restorable. For example, the program may be compressed or encrypted before storage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first associating unit that associates information concerning a customer having entered a store through an entrance and exit with information concerning a line of flow of the customer from a photographed image of an inside of the store;
a second associating unit that associates information concerning a line of flow of the customer from a cashier area to the entrance and exit with information concerning purchasing in the store;
a third associating unit that associates information concerning a customer having entered the store through the entrance and exit with information concerning a customer having left the store through the entrance and exit; and
a fourth associating unit that associates the information concerning the purchasing with information concerning the line of flow of the customer in the store using information associated by the first through third associating units.

2. The information processing apparatus according to claim 1, wherein the information concerning the customer having entered or left the store through the entrance and exit is extracted from a first image photographed from above the entrance and exit, and
wherein the information concerning the line of flow of the customer in the store and the information concerning the line of flow of the customer from the cashier area to the entrance and exit are extracted from a second image as a photographed image of the inside of the store.

3. The information processing apparatus according to claim 1, wherein the third associating unit associates the information concerning the customer having entered the store with the information concerning the customer having left the store by associating an image of the customer having entered the store with an image of the customer having left the store and being symmetrical with the image of the customer having entered the store.

4. The information processing apparatus according to claim 2, wherein the third associating unit associates the information concerning the customer having entered the store with the information concerning the customer having left the store by associating an image of the customer having entered the store with an image of the customer having left the store and being symmetrical with the image of the customer having entered the store.

5. The information processing apparatus according to claim 1, wherein the fourth associating unit associates the information concerning the purchasing with the information concerning the line of flow of the customer in the store by extracting the information concerning the customer having entered the store from the information concerning the line of flow of the customer in the store, extracting the information of the customer having left the store from the information of the customer having entered the store, extracting the information concerning the line of flow of the customer from the cashier area to the entrance and exit from the information concerning the customer having left the store, and extracting the information concerning the purchasing from the information concerning the line of flow of the customer from the casher area to the entrance and exit.

6. The information processing apparatus according to claim 2, wherein the fourth associating unit associates the information concerning the purchasing with the information concerning the line of flow of the customer in the store by extracting the information concerning the customer having entered the store from the information concerning the line of flow of the customer in the store, extracting the information of the customer having left the store from the information of the customer having entered the store, extracting the information concerning the line of flow of the customer from the cashier area to the entrance and exit from the information concerning the customer having left the store, and extracting the information concerning the purchasing from the information concerning the line of flow of the customer from the casher area to the entrance and exit.

7. The information processing apparatus according to claim 3, wherein the fourth associating unit associates the information concerning the purchasing with the information concerning the line of flow of the customer in the store by extracting the information concerning the customer having entered the store from the information concerning the line of flow of the customer in the store, extracting the information of the customer having left the store from the information of the customer having entered the store, extracting the information concerning the line of flow of the customer from the cashier area to the entrance and exit from the information concerning the customer having left the store, and extracting the information concerning the purchasing from the information concerning the line of flow of the customer from the casher area to the entrance and exit.

8. The information processing apparatus according to claim 4, wherein the fourth associating unit associates the information concerning the purchasing with the information concerning the line of flow of the customer in the store by extracting the information concerning the customer having entered the store from the information concerning the line of flow of the customer in the store, extracting the information of the customer having left the store from the information of the customer having entered the store, extracting the information concerning the line of flow of the customer from the cashier area to the entrance and exit from the information concerning the customer having left the store, and extracting the information concerning the purchasing from the information concerning the line of flow of the customer from the casher area to the entrance and exit.

9. A information processing method comprising:
associating information concerning a customer entering a store through an entrance and exit with information related a line of flow of the customer from a photographed image of an inside of the store;
associating information concerning a line of flow of the customer extending from a cashier area to the entrance and exit with information concerning purchasing in the store;
associating information concerning a customer having entered the store through the entrance and exit with information concerning a customer having left the store through the entrance and exit; and
associating the information concerning the purchasing with information concerning the line of flow of the customer in the store using information associated by the first through third associating units.

10. A non-transitory computer readable medium storing a program causing a computer to execute a process for processing information, the process comprising:
associating information concerning a customer entering a store through an entrance and exit with information related a line of flow of the customer from a photographed image of an inside of the store;
associating information concerning a line of flow of the customer extending from a cashier area to the entrance and exit with information concerning purchasing in the store;
associating information concerning a customer having entered the store through the entrance and exit with information concerning a customer having left the store through the entrance and exit; and
associating the information concerning the purchasing with information concerning the line of flow of the customer in the store using information associated by the first through third associating units.
